(19) United States
(12) Patent Application Publication
(10) Pub. No.: US 2010/0252494 A1
(43) Pub. Date: Oct. 7, 2010

(54) FLUID SUPPLY DEVICE AND FUEL SUPPLY DEVICE

(75) Inventors: Nobuyuki Kitajima, Tosu-shi (JP); Hideo Nakaoka, Yokohama-shi (JP)

Correspondence Address: BRINKS HOFER GILSON & LIONE, P.O. BOX 10395, CHICAGO, IL, 60610, US

(73) Assignee: YAMASHIN-FILTER CORP., Yokohama-shi (JP)

(21) Appl. No.: 12/572,604

(22) Filed: Oct. 2, 2009

(30) Foreign Application Priority Data
Apr. 7, 2009 (JP) JP2009-093253

(51) Int. Cl. B01D 29/90

(52) U.S. Cl. 210/258; 210/416.1; 210/416.4

(57) ABSTRACT

A fluid supply device may include a pump device that moves fluid, and a filter device that filters fluid which flows due to operation of the pump device. The pump device may include a pump device housing that comprises a first coupling member which enables the fluid to flow therethrough. The filter device may include a filter device housing that holds a filter element. The filter device housing may have a second coupling member that enables fluid to flow therethrough. The filter device and the pump device may be coupled by a tube member that enables the fluid to flow internally between the pump device and the filter device. Preferably, at least a part of the pump device is interposed between the filter device and the wall such that the pump device overlaps with the filter device in a direction in which the base extends.

### RELATED APPLICATION

The present application claims the benefit of Japanese Patent Application Number 2009-093253, filed on Apr. 7, 2009, the entirety of which is hereby incorporated by reference.

### TECHNICAL FIELD

The present invention relates to a technology for supplying fuel to a fuel tank of, for example, heavy machinery.

### BACKGROUND ART

Heretofore, heavy machinery such as a hydraulic back hoe was equipped with a fuel tank containing fuel which is to be supplied to an engine. In addition, a pump was provided to the heavy machinery in order to supply fuel to the inside of the fuel tank. Accordingly, in heavy machinery equipped with a pump, fuel is replenished to the inside of the fuel tank from a fuel supply source such as a fuel reserve tank disposed on the outside of the heavy machinery, by a pump. The fuel contained in the fuel tank is supplied to the engine.

However, it is undesirable for debris and other contaminants to enter the fuel which is supplied to the engine. Structures have been proposed having a fuel filter provided in the flow channel of the fuel from the fuel tank to the engine. The fuel filter makes it possible to remove debris and other contaminants from the fuel supplied to the engine. (For example, see Patent Reference 1.)

Patent Reference 1: Japanese Patent Application Kokai Publication No. 2002-89391

However, in this reference, it is conceivable that debris and other contaminants in the fuel could remain in the fuel tank. In particular, in the case of machinery that operates for long periods of time, such as heavy machinery, fuel is supplied to the fuel tank with increasing frequency, and it is therefore conceivable that debris and other contaminants may remain in the fuel tank.

The technology disclosed in Patent Reference 1 discloses removing debris and other contaminants from the fuel prior to introducing it into the engine, but it is conceivable that debris and other contaminants may still remain in the fuel tank. It is undesirable for debris and other contaminants to remain in the fuel tank.

Therefore, it has become apparent to the inventors that an improved fluid supply device capable of filtering fuel and inhibiting debris and other contaminants from remaining in a fuel tank is desirable.

### SUMMARY OF THE INVENTION

Improved fluid and fuel supply devices are described which may inhibit debris and other contaminants from remaining in a fuel tank. The invention may include any of the following aspects in various combinations and may also include any other aspect described below in the written description or in the attached drawings.

In one aspect, a fluid supply device may include a pump device that moves fluid and a filter device that filters fluid which flows due to operation of the pump device. The pump device may include a pump device housing. Preferably, the pump device housing includes a first coupling member which enables the fluid to flow therethrough. The filter device may include a filter device housing that holds a filter element. Preferably, the filter device housing has a second coupling member that enables fluid to flow therethrough, and the first and second coupling members may be coupled to each other.

In another aspect, the filter device may be provided with an immobilizing base, and at least a part of the pump device is preferably disposed such that the at least a part of the pump device overlaps with the filter device in a direction in which the base extends.

The filter device and the pump device may be coupled to each other by a tube member that enables the fluid to flow internally between the pump device and the filter device.

In one aspect, the fluid supply device may also include a pump device tube member coupled to the pump device, and a filter device tube member coupled to the filter device.

In one embodiment, the fuel supply device may include a pump device which delivers fuel to the inside of a fuel tank attached to machinery, and a filter device which filters the fuel before it enters into the fuel tank. The pump device and the filter device may be attached to the machinery.

The pump device may include a pump device housing equipped with a first coupling member that enables the fuel to flow therethrough. Preferably, the filter device is provided with a filter device housing which holds a filter element. The filter device housing may have a second coupling member that enables fuel to flow therethrough, and the first and second coupling members may be coupled to each other.

In one aspect, the filter device and the pump device may be affixed to a wall of the device. In another aspect, the filter device includes a base for affixing the filter device to the wall, and at least a part of the pump device is interposed between the filter device and the wall such that at least a part of the pump device overlaps with the filter device in a direction in which the base extends.

In yet another aspect, the filter device and the pump device are coupled by a tube member that enables the fluid to flow internally between the pump device and the filter device.

The filter device and the pump device may be affixed to a wall of the device. The fuel supply device may also include a pump device tube member coupled to the pump device, and a filter device tube member coupled to the filter device. The fuel supply device may also include a flow pathway which guides the fuel from within the tank to the filter device.

In one aspect, the fuel supply device may further include a switch that switches between a first condition in which fuel within the tank is not guided to the filter device and a second condition in which the fuel within the tank is guided to the filter device through the flow pathway. In another aspect, the fuel supply device may include a second tank.

The foregoing paragraphs have been provided by way of general introduction, and are not intended to limit the scope of the following claims. The presently preferred embodiments, together with further advantages, will be best understood by reference to the following detailed description taken in conjunction with the accompanying drawings.

### BRIEF DESCRIPTION OF THE DRAWINGS

FIG. 1 is an enlarged perspective view of an exterior of a fuel supply device in a retainer that is equipped on a back hoe according to the first embodiment of the present invention.

FIG. 2 shows a state in which a fuel supply device is held within the retainer shown in FIG. 1

FIG. 3 is a plan view of the inside of the retainer shown in FIG. 1 as seen from the side of the cover member.

FIG. 4 is a frontal view of the fuel supply device shown in FIG. 1.

FIG. 5 is a side view of the fuel supply device shown in FIG. 1.

FIG. 6 is a frontal view showing a state in which part of the filter device is cut out in the fuel supply device shown in FIG. 4.

FIG. 7 is a frontal view of the fuel supply device according to the second embodiment, with a part of the filter device cut out.

FIG. 8 is a perspective view of the fuel supply device according to the third embodiment of the present invention.

FIG. 9 is a perspective view of the fuel supply device according to the fourth embodiment of the present invention.

FIG. 10 is a sectional view of the filter device along the line F10-F10 in FIG. 9.

FIG. 11 is a perspective view showing the fuel supply device of the fifth embodiment of the present invention.

### DETAILED DESCRIPTION OF THE PREFERRED EMBODIMENTS

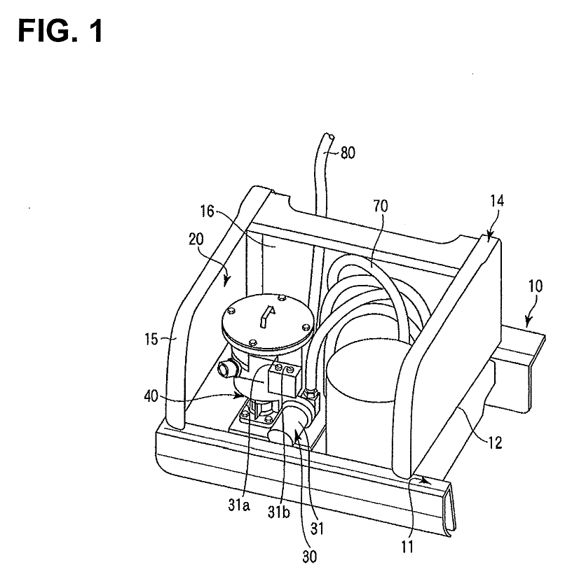

A fuel supply device according to the first embodiment of the present invention is described in FIGS. 1-6. The fuel supply device according to the present embodiment is used in heavy machinery such as a back hoe 10, for example. In the present embodiment, the back hoe 10 is an example of machinery equipped with the fuel tank referred to in this specification. It should be noted that machinery equipped with a fuel tank is not limited to the back hoe 10. For example, the machinery may be any type of heavy machinery, construction machinery, automotive vehicles, and the like, provided the machinery is equipped with a fuel tank.

FIG. 1 is an enlarged perspective view of a portion of the appearance of the back hoe 10 (as seen from the outside). A wall portion 12 of an outer wall 11 determines the appearance of the back hoe 10 is illustrated in FIG. 1.

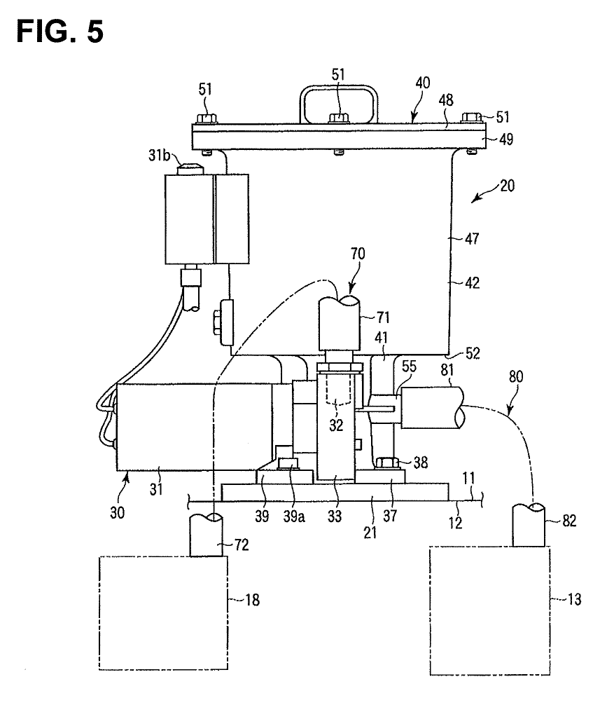

The back hoe 10 is driven (runs) by a driving force generated by an engine which is not pictured. Accordingly, the back hoe 10 is equipped with an engine, which is not pictured, and with a fuel tank 13 (shown in FIG. 5), which stores fuel for driving the engine.

The fuel tank 13 is disposed close to the side of the wall portion 12 of the outer wall 11 of the back hoe shown in FIG. 1, for example. It should be noted that the fuel tank 13, indicated by a double-dashed line in FIG. 5, is pictured schematically so as to describe the flow of fuel below, but it is not pictured in its actual position as installed in the back hoe 10.

The back hoe 10 is equipped with a fuel supply device 20 which replenishes fuel to the inside of the fuel tank 13. The fuel supply device 20 is an exemplary embodiment of the fluid supply device referred to in this specification. The fuel supply device 20 may be equipped with a pump device 30, a filter device 40, a mounting plate 21, a first tube member 70, and a second tube member 80.

The mounting plate 21 is a platform upon which the pump device 30 and the filter device 40 are affixed. The fuel supply device 20 has the pump device 30 and the filter device 40 affixed on the mounting plate 21, thereby forming a single unit. As shown in FIG. 1, because the mounting plate 21 is affixed to the wall portion 12 of the outer wall 11 of the back hoe 10, the fuel supply device 20 forming the above-described unit 20 (with the pump device 30 and the filter device 40 affixed on the mounting plate 21) is disposed at the wall portion 12 in the back hoe 10.

The following is a description of the wall portion 12 (the portion pictured) of the outer wall 11 of the back hoe 10. The wall portion 12 is disposed close to the side of the fuel tank 13 and within the outer wall 11, which is exposed to the outside of the back hoe 10. Thus, the wall portion is positioned in a site which ensures that there is adequate installation space.

In the present embodiment, an example of the wall portion 12 is a horizontal surface which extends almost perpendicularly to the direction of gravitational force when the back hoe 10 (the exemplary device referred to in this specification) is set on a horizontal surface (a surface perpendicular to the direction of gravitational force). It should be noted that the direction which is almost perpendicular to the direction of gravitational force is a concept which also includes the direction which is strictly perpendicular.

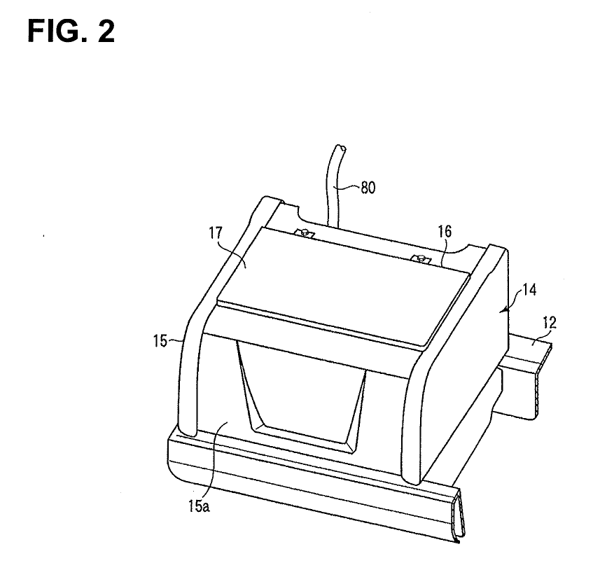

A retainer 14, which holds the fuel supply device 20, is provided to the wall portion 12. FIG. 2 shows a state in which the fuel supply device 20 is held within the retainer 14. As shown in FIG. 2, the retainer 14 is equipped with a peripheral wall 15, which is disposed around the fuel supply device 20 rises from the wall portion 12 of the outer wall 11, and a cover member 17, which covers the opening that is limited by the end portion of the peripheral wall 15.

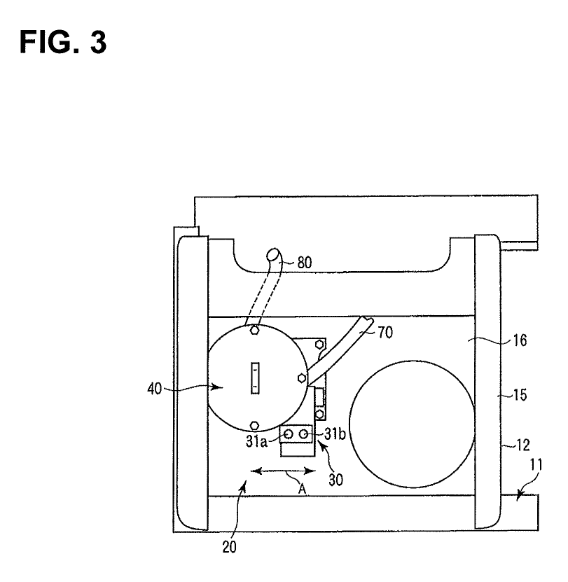

A portion 15a of the peripheral wall 15 and the cover member 17 may be removed. FIGS. 1 and 3 show states in which the portion 15a of the peripheral wall 15 and the cover member 17 have been removed. FIG. 3 is a plan view of the inside of the retainer 14 as seen from the side of the cover member 17.

As shown in FIGS. 1 and 3, in states in which the portion 15a of the peripheral wall 15 and the cover member 17 have been removed, the pump device 30 and the filter device 40 become exposed to the outside such that that the pump device 30 and the filter device 40 become operable from the outside.

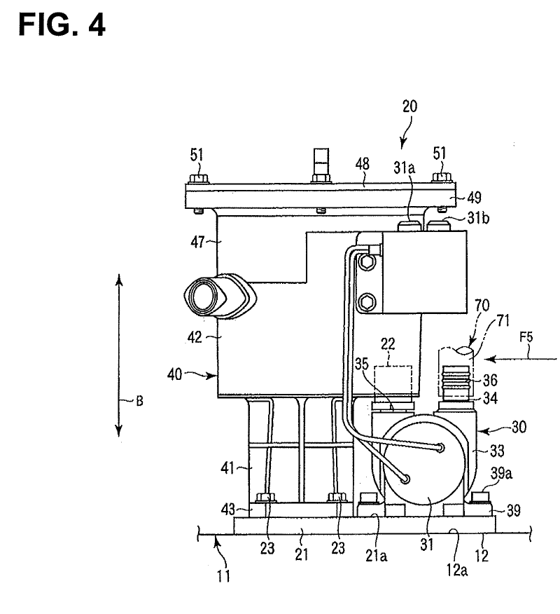

Returning to a description of the fuel supply device 20, the fuel supply device 20 will be described in a state in which the fuel supply device 20 is affixed to the wall portion 12 of the outer wall 11 of the back hoe 10. FIG. 4 is a frontal view of the pump device 30 and the filter device 40 in the fuel supply device 20. It should be noted that in the drawing, the first tube member 70 is shown with a double-dashed line. The pump device 30 is used to move fuel from inside a fuel reserve tank 18 (shown in FIG. 5), which is an example of a fuel supply source, on the outside of the back hoe 10, to inside the fuel tank 13. The first tube member 70 is an exemplary embodiment of the tube member for the pump device referred to in this specification.

FIG. 5 is a side view of the fuel supply device 20. FIG. 5 shows a state in which the fuel supply device 20 of FIG. 4 is viewed along the direction of an arrow F5. As shown in FIG. 5, the pump device 30 is equipped with a driving member 31, which generates a suction force that draws the fuel into the fuel reserve tank 18, and a pump device housing 33 having a flow pathway 32 formed to allow the fuel to be drawn in by the driving member 31.

As shown in FIG. 4, the pump device 30 is equipped with an intake port 34 and a discharge port 35. The intake port 34 and the discharge port 35 are formed in the pump device housing 33. The flow pathway is linked to the intake port 34 and the discharge port 35. The intake port 34 and the discharge port 35 open toward the side opposite the wall portion 12 of the outer wall 11 in the pump device housing 33. The intake port 34 and the discharge port 35 are disposed in positions adjacent to each other.

A tube member coupling part 36 that couples the first tube member 70 as described below is provided to the intake port 34. The tube member coupling part 36 protrudes toward the side opposite the wall portion 12 of the outer wall 11. A coupling member 22 is formed at the discharge port 35, as shown by the dotted line in FIG. 4. The coupling member 22 protrudes toward the side opposite the wall portion 12 of the outer wall 11. The coupling member 22 is an exemplary embodiment of the first coupling member referred to in this specification.

The driving member 31 forms a component that may be separate from the pump device 33, for example, and is attached to the pump device housing 33. Alternatively, the driving member 31 may be housed in the pump device housing 33. The driving member 31 is powered, for example, by electricity. A suction force is generated when the driving member 31 performs its driving operation. This suction force causes the fuel to flow in the flow pathway 32 through the intake port 34, and to be discharged from the discharge port 35.

The pump device 30 is affixed to the mounting plate 21. The mounting plate 21 is, for example, a flat plate, which is affixed by welding or the like to the wall portion 12 of the outer wall 11. It should be noted that the method of affixing the mounting plate 21 is not limited to welding.

A top surface 21a of the mounting plate 21 and a surface affixed to the wall portion 12 at the mounting plate 21 (the surface on the side opposite to the top surface 21a) are flat surfaces which are parallel to each other. A surface 12a is disposed at the position the mounting plate 21 is affixed to the wall portion 12. The surface 12a is, for example, a flat surface. For this reason, the surface 12a and the top surface 21a are parallel flat surfaces.

As shown in FIG. 5, a platform 37, affixed on the surface 21a of the mounting plate 21, is provided to the pump device housing 33. The bottom surface of the platform 37 is flat, so that it can be affixed and stabilized on the top surface 21a of the mounting plate 21. This bottom surface touches the top surface of the mounting plate 21. The platform 37 is affixed to the mounting plate 21 by means of a bolt 38, for example.

Likewise, a platform 39 with a structure similar to that of the platform 37 formed for the pump device housing 33 is formed for the driving member 31 as well. The platform 39 has, for example, a flat bottom surface which touches the top surface of the mounting plate 21 so that it can be affixed and stabilized on the mounting plate 21. The platform 37 is affixed to the mounting plate 21 by a bolt 39a, for example. It should be noted that if the driving member 31 has a structure such that it is housed within the pump device housing 33. A platform may be formed only for the pump device housing 33.

The pump device 30 is thus affixed to the outer wall 11 of the back hoe 10 by the mounting plate 21. The outer wall 11 is an exemplary embodiment of a wall referred to in this specification. The wall portion 12 of the outer wall 11 is reinforced by the mounting plate 21, so that even if the fuel supply device 20 is installed, reliable strength is ensured. It should be noted that if sufficient strength is ensured, the pump device 30 may be directly affixed to the outer wall 11 without using the mounting plate 21.

Affixing to the wall, as referred to in this specification, includes affixing to the wall by the mounting plate 21, as described in the present embodiment, as well as directly affixing to the wall.

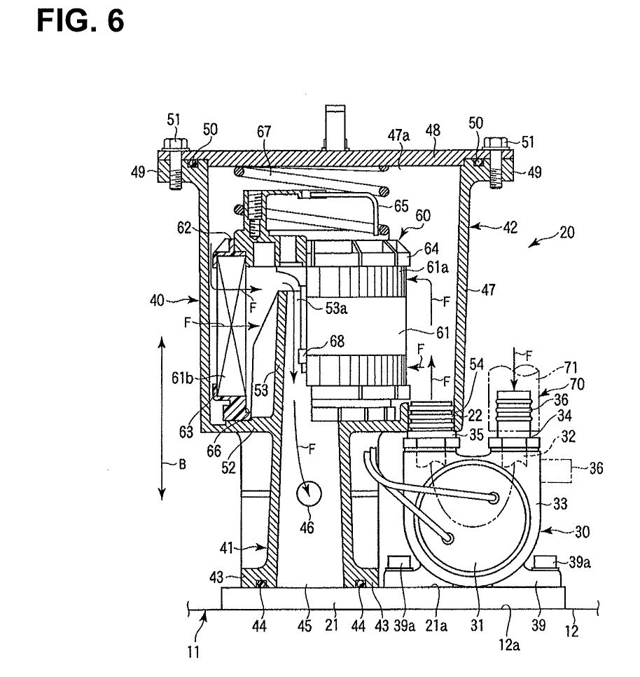

FIG. 6 is a frontal view showing a state in which part of the filter device 40 is cut out in the fuel supply device 20 shown in FIG. 4. As shown in FIG. 6, the filter device 40 is provided with a base 41, a filter device housing 42, and a filter element 60.

The base 41 is affixed to the mounting plate 21. The base 41 is disposed fixedly at a position adjacent to the pump device 30 on the mounting plate 21. The base 41 extends from the mounting plate 21 toward the opposite side of the wall portion 12 of the outer wall 11, holding the mounting plate 21 between them. The base 41 extends rectilinearly in one example, extending in direction B. In one example, the base 41 extends in a perpendicular direction with respect to the top surface 21a of the mounting plate 21. If the base 41 is not affixed by the mounting plate 21, it may extend in a perpendicular direction with respect to the wall portion 12.

The base 41 is cylindrical, and the end on the side of the mounting plate 21 is open. A flange 43 having a flat bottom surface is formed on the periphery of the base 41. The flat bottom surface can make contact with a surface of the mounting plate 21 with so as to be stably affixed to the mounting plate 21. A sealing structure such as an O-ring 44 is provided between the flange 43 and the mounting plate 21. The O-ring 44 has a configuration which surrounds the periphery of an opening 45.

As shown in FIG. 4, the flange 43 is affixed to the mounting plate 21 by a plurality of bolts 23, for example. When the flange 43 is affixed to the mounting plate 21, the opening 45 of the base 41 is sealed fluid-tight by the O-ring 44 and the mounting plate 21. Consequently, there is no leakage of fluid such as oil from between the base 41 and the mounting plate 21. An outflow port 46 is formed on the peripheral wall of the base 41.

The filter device housing 42 is equipped with a housing main body 47, which accommodates the filter element 60, and a cover member 48. The housing main body 47 is affixed to the end on the opposite side of the mounting plate 21 on the base 41, thereby forming an integrated whole with the base 41. In other words, the base 41 extends along the direction B from the housing main body 47 to the wall portion 12.

Due to the fact that the base 41 is affixed to the mounting plate 21, the filter device housing 42 is affixed to the mounting plate 21. The concept of having the filter device affixed to the wall, as described in this specification, includes indirectly affixing it by a mounting plate, as described above.

Moreover, the concept of having the base affix the filter device to the wall, as described in this specification, includes affixing the base 41 directly to the wall (or the wall portion 12). As in the description of the pump device 30, the base 41 may be directly affixed to the wall portion 12 of the outer wall 11, without using the mounting plate 21.

The housing main body 47 has a hollow configuration capable of accommodating the filter element 60 inside it, and forms, for example, a cylinder with a bottom having a bottom wall part 52. The end of the housing main body 47 is open on the side opposite the base 41. The filter element 60 described below passes through this opening and is installed within the housing main body 47. The base 41 is affixed to the bottom wall part 52.

A driving switch 31a, which drives the driving member 31 of the pump device 30, and a release switch 31b for releasing the drive are attached on an outer surface of the housing main body 47 at a position facing the portion 15a of the peripheral wall 15.

The cover member 48 seals the opening 47a of the housing main body 47 to make it fluid-tight. A flange 49 surrounding the opening 47a is formed at the rim of the opening 47a of the housing main body 47. As an example of a sealing structure, an O-ring 50 is inserted in the flange 49 and disposed between it and the cover member 48 thereby surrounding the opening 47a. The opening 47a is sealed fluid-tight by the O-ring 50 and the cover member 48, since the cover member 48 is affixed to the flange 49. Thus, a fluid such as fuel does not pass through the opening 47a and leak to the outside.

The bottom wall part 52 of the housing main body 47 has a protruding portion 53 which protrudes toward the inside. The bottom part 52 is at a position where the base 41 is provided in the housing main body 47. Moreover, the bottom part 52 faces the mounting plate 21 (including the wall portion 12) in the direction B along which the base 41 extends. As an example, the bottom wall part 52 is flat and faces the mounting plate 21.

The protruding portion 53 extends toward the side opposite the mounting plate 21. The protruding portion 53 is a hollow cylinder which is linked rectilinearly to the inside cavity of the base 41. In this embodiment, as an example, when the back hoe 10 (an example of machinery referred to in this specification) is arranged on a horizontal surface (a surface perpendicular to the direction of gravitational force), the base 41 and the protruding portion 53 extend approximately in the direction of gravitational force. Here, the concept of extending approximately in the direction of gravitational force includes strictly the direction of gravitational force. The protruding portion 53 extends approximately in the intermediate position between the bottom wall port 52 and the opening 47a within the housing main body 47.

The inner end portion 53a of the protruding portion 53 is open. The inner cavity of the housing main body 47 and the inner cavity of the base 41 are therefore linked together.

The filter element 60 is equipped with a cylindrical filter 61 open at both ends, a first end member 62 provided at the end of the filter 60, a second end member 63, and a cover member 64.

The filter 61 is formed, for example in a pleated cylinder which folds, and is open at both ends. The first end member 62 is provided at one end 61a of the filter 61, and supports the end 61a. The first end member 62 seals the parts at the terminal surface of the end 61a, which are actually parts of the filter 61, other than the opening so as to be fluid-tight. Additionally, the first end member 62 has an opening which is linked to the opening of the filter 61.

The second end member 63 is provided at the other end 61b of the filter 61, and serves to support the other end 61b. The second end member 63 seals the parts, other than the opening, at the terminal surface of the end 61b (which are actually parts of the filter 61) so as to be fluid-tight. Additionally, the second end member 63 has an opening which is linked to the opening of the filter 61.

The cover member 64 is provided at the side of the end 61a. Specifically, the cover member 64 is provided to the first end member 62, and seals the opening of the first end member 62 so that it is fluid-tight. A handle 65 is provided to the cover member 64 so that an operator can hold it.

The filter element 60 with the structure described above has an end surface (including the opening) of the end 61a of the filter 61 which is sealed fluid-tight by the first end member 62 and the cover member 64. The end surface of the other end 61b is such that the inside and outside of the filter 61 are linked by an opening of the second end member 63, while the filter 61 is actually sealed fluid-tight by a portion of the second end member 63.

The filter element 60 is arranged within the housing main body 47 with the protruding portion 53 inserted inside the filter 61 passing through an opening 66 of the second end member 63. In this arrangement, the second end member 63 makes contact with the bottom wall part 52, so that the opening 66 is sealed fluid-tight by the bottom wall part 52.

As an example of a structure producing the above operation, a spring element 67 is disposed between the cover member 64 of the filter element 60 and the cover member 48 of the filter device housing 42. The spring element 67 is a coiled spring. The spring element 67 is formed so that the handle 65 of the cover member 64 will be held inside, and since it is supported by the handle 65, it is positioned between the cover members 64 and 48.

When the filter element 60 is accommodated within the housing main body 47 and the cover member 48 is affixed to the housing main body 47 by a bolt 51, the spring element 67 is compressed between the cover members 48 and 64. Accordingly, the filter element 60 is pressed against the bottom wall part 52. Due to this compressive force, the rim of the opening 66 of the second end member 63 is pressed against the bottom wall part 52, thereby sealing the opening fluid-tight.

Due to the fact that the filter element 60 is accommodated within the housing main body 47 as described above, the ends 61a and 61b of the filter 61 are sealed fluid-tight by the first and second end members 62 and 63, the cover member 64, and the bottom wall part 52. The inside of the filter 61 is linked to the inner cavity of the base 41, thereby bypassing the protruding portion 53.

A relief valve 68 is provided to the cover member 64 of the filter element 60. The relief valve 68 opens in the event that the pressure within the housing main body 47 becomes too great. When the relief valve 68 opens, the inside of the filter 61 is linked to the housing main body 47, through the cover member 64. The relief valve 68 is set so that it does not open during normal operation of the fuel supply device 20.

The housing main body 47 is coupled to the pump device housing 33. The following is a detailed description of the coupling structure for the housing main body 47 and the pump device housing 33.

As shown in FIG. 6, when the filter element 60 is housed within the housing main body 47, an inflow port 54 is formed in the bottom wall part 52 at a position which does not overlap with the filter element 60. Accordingly, the inflow port 54 is open at the side of the mounting plate 21. The inflow port 54 is an exemplary embodiment of a second coupling member.

The coupling member 22, which is formed at the discharge port 35 of the pump device housing 33, is inserted into and engages with the inflow port 54, so that the coupling member 22 and the inflow port 54 are coupled in a fluid-tight manner. Thus, fluid expelled from the discharge port 35 passes through the coupling member 22 and the inflow port 54, flowing into the housing main body 47, without leaking to the outside.

Accordingly, since the inlet port 54 is formed within the housing main body 47, the filter element 60 is arranged so as to be biased in whatever direction will avoid the inflow port 54. In the present embodiment, as an example, the filter element 60 is arranged in a position biased toward the peripheral wall of the housing main body 47 in direction A in which the filter device 40 and the pump device 30 are aligned (or in a direction parallel to the direction A) in the housing main body 47. The direction A in which the filter device 40 and the pump device 30 are aligned is shown by an arrow in FIG. 3. In other words, the base 41 and the protruding portion 53 are provided in a position biased as described above.

Due to the fact that the filter device 40 and the pump device 30 are coupled to each other in the manner described above, a portion of the pump device 30 becomes inserted between the housing main body 47 and the mounting plate 21 so as to overlap with the base 41 in a direction B in which the base 41 extends. The coupling member 22 extends in the direction B, for example.

Due to the fact that the tube member coupling part 36 avoids interfering with the housing main body 47 by adjusting the size of the pump device 30 or by changing the position at which the tube member coupling part 36 is formed, as shown by the dashed line in FIG. 6, the entire pump device 30 may be interposed between the housing main body 47 and the mounting plate 21 so that it overlaps with the housing main body 47 in the direction B. The tube member coupling part 36 indicated by the double-dashed line is an example of a case where the position of the coupling part 36 is changed. In this case, an intake port 34 is formed so as to be linked to the tube member coupling part 36.

Accordingly, the filter device 40 and the pump device 30 overlap due to the fact that at least a part of the pump device 30 overlaps with the housing main body 47 in direction B by being interposed between the housing main body 47 and the mounting plate 21. That is, by being interposed between the housing main body 47 and the wall portion 12 of the outer wall 11, at least a part of the pump device 30 overlaps with the housing main body 47 in direction B. Consequently, the installation space for the fuel supply device 20 in the outer wall 11 of the back hoe 10 can be made compact. Moreover, the pump device 30 can function as a support for the filter device 40.

As shown in FIG. 5, one end 71 of the first tube member 70 is coupled and affixed to the tube member coupling part 36, which is formed at the intake port 34 of the pump device 30, and is linked to the intake port 34. The other end 72 of the first tube member 70 is coupled to a fuel supply source, such as the fuel reserve tank 18, when fuel is replenished to the fuel tank 13. In other words, when oil is not replenished, the other end 72 of the first tube member 70 is not connected to a fuel supply source and the first tube member 70 is coiled so as to be accommodated next to the pump device 30 and the filter device 40, as shown in FIG. 1. Thus, the first tube member 70 has the flexibility to be coiled.

The second tube member 80 is coupled to the outflow port 46 formed at the base 41. Specifically, as shown in FIG. 5, an outflow port coupling member 55, which protrudes to the outside, is formed on the outer surface of the base 41, and is linked to the outflow port 46. One end 81 of the second tube member 80 is coupled and affixed to the outflow port coupling member 55. The second tube member 80 is an example of a filter device tube member.

The other end 82 of the second tube member 80 is always coupled to the fuel tank 13. Thus, as shown in FIG. 1, the second tube member 80 exits from the housing. The second tube member 80 is flexible so as to be able to couple with the outflow port 46 and the fuel tank 13 irrespective of the relative positions of the outflow port 46 and the fuel tank 13. It should be noted that the second tube member 80 is partly omitted from FIGS. 1 and 2.

The following is a description of an example of the assembly procedure for the fuel supply device 20, and a description of an exemplary method of how the fuel supply device 20 is affixed to the wall portion 12 of the outer wall 11.

After the pump device 30 and the filter device 40 are affixed to the mounting plate 21 to form an integral unit, as described above, the mounting plate 21 is affixed to the wall portion 12, so that the fuel supply device 20 is affixed to machinery, such as the back hoe 10, equipped with the fuel tank 13.

In an example of the assembly procedure for the fuel supply device 20, first, the pump device 30 is affixed to the mounting plate 21. In doing this, the pump device 30 is affixed in a specified position on the mounting plate 21.

Next, the filter device 40 is affixed to the mounting plate 21. In this step, the coupling member 22 of the pump device 30 is inserted into the inflow port 54 and engages therewith. Also, the position of the filter device 40 is adjusted so that at least one part of the pump device 30 overlaps with the housing main body 47 in the direction B in which the base 41 extends. The filter device 40 is then affixed to the mounting plate 21.

Next, the first and second tube members 70, 80 are attached, so that the fuel supply device 20 is formed as a single unit.

The mounting plate 21 is affixed to the wall portion 12 in order to affix the fuel supply device 20 to the wall portion 12 of the outer wall 11. By affixing in this manner, the fuel supply device 20, which is formed so that at least a part of the pump device 30 overlaps with the housing main body 47 in the direction B, is interposed between the housing main body 47 and the wall portion 12 in the direction B in which at least a part of the pump device 30 extends.

The following is a description of the operation of the fuel supply device 20. As shown in FIG. 2, when there is no replenishment of fuel to the fuel tank 13, the retainer 14 has the cover member 17 and a portion 15a of the peripheral wall 15 attached.

As shown in FIG. 1, when fuel is replenished to the fuel tank 13, a portion 15a of the peripheral wall 15 of the retainer 14 and the cover member 17 are removed. Then, as shown in FIG. 5, the other end 72 of the first tube member 70 is coupled to a fuel source such as the fuel reserve tank 18.

The driving switch 31a, which drives the driving member 31 of the pump device 30, is then activated. When the driving switch 31a is activated, the driving member 31 operates, so fuel flows into the pump device housing 33 from the intake port 34, passing from the fuel reserve tank 18 through the first tube member 70. Next, as shown by the arrow in FIG. 6, fuel F passes through the flow pathway 32 (partially indicated by a dotted line in the drawing; note that other parts are omitted or indicated by double-dashed lines), flowing from the discharge port 35 and the coupling member into the housing main body 47.

The fuel F is the fuel referred to in this specification, and is an exemplary embodiment of a fluid. Additionally, the act of moving the fuel F from the fuel reserve pump 18 to the fuel tank 13 with the pump device 30 is an example of the movement of fluid referred to in this specification.

The fuel F which flowed into the housing main body 47 flows from the side of the filter 61 of the filter element 60 into the filter 61, passing to the inside of the filter 61. In so doing, the fuel F is filtered by the filter 61, so that debris and other contaminants in the fuel F are removed.

The fuel F, which enters the inside of the filter 61, is filtered by the filter 61. The fuel filtered by the filter 61 passes through the inside of the protruding portion 53 and the inside of the base 41, and reaches the outflow port 46.

Next, the filtered fuel flows from the outflow port 46 into the second tube member 80, passes through the second tube member 80, and enters the fuel tank 13.

Thus, due to the operation of the fuel supply device 20, the fuel tank 13 is replenished with fuel after filtration.

When fuel replenishment is completed, the release switch 31b of the pump device 30 is deployed. When the release switch 31a is activated, the driving member 31 stops operating, thereby stopping the supply of fuel to the fuel tank 13.

A sensor for detecting whether enough fuel has been replenished may be provided at the end of the fuel tank side of the second tube member 80. The driving member 31 automatically stops operating based on the detected results of the sensor. That is, the driving member 31 automatically stops if sufficient fuel has been replenished to the fuel tank 13. If this structure is used, the pump device 30 will stop, without the operator activating the drive stop switch, when a sufficient amount of fuel is replenished to the fuel tank 13.

In a fuel supply device 20 constructed in such a manner, the fuel is filtered by the filter device 40 before replenishing (entering) the fuel tank 13. In other words, the fuel supply device 20 can filter fluids such as fuel which is supplied to the fuel tank 13. Accordingly, fuel is replenished to the fuel tank 13 after debris and other contaminants are removed by filtration, thereby making it possible to inhibit debris and other contaminants from remaining in a fuel tank 13.

The pump device housing 33 of the pump device 30 and the filter device housing 42 of the filter device 40 are directly coupled to each other due to the fact that the coupling member 22 and the inflow port 54 are coupled.

Accordingly, the fuel supply device 20 can be made compact, since the pump device housing 33 and the filter device housing 42 are not coupled by a separate component such as a tube member.

Due to the fact that the filter device housing 42 is affixed to the wall portion 12 of the outer wall 11 (which is affixed by the base 41 and the mounting plate 21 in the present embodiment), and due to the fact that the pump device housing 33 is affixed to the wall portion 12 (affixed by the mounting plate 21 in the present embodiment), the filter device housing and the wall portion 12 support each other. Consequently, the fuel supply device 20 is firmly supported and affixed to machinery, such as the back hoe 10.

As a result, even in the case of machinery subject to relatively large vibrations, such as the back hoe 10 or other construction or heavy machinery, in the present embodiment it is possible to install the fuel supply device 20.

The act of affixing the filter device housing 42 to the wall portion 12 is an example of the filter device 40 being affixed to the wall portion 12. When the pump device housing 33 is affixed to the wall portion 12, it is an example of the pump device 30 being affixed to the wall portion 12.

At least one part of the pump device 30 is formed so as to overlap with the housing main body 47 in direction B in which the base 41 extends.

Accordingly, it is possible to reduce the installation space for the fuel supply device 20, since the housing main body 47 and the pump device 30 are arranged to overlap. Consequently, it becomes easy to install the fuel supply device 20 in machinery such as the back hoe 10.

Moreover, at least a part of the pump device 30 is arranged so as to be interposed between the housing main body 47 and the wall portion 12, so that it overlaps with the housing main body in the direction B in which the base 41 extends. Thus, it is possible to further reduce the installation space of the fuel supply device 20. Consequently, it becomes easy to install the fuel supply device 20 in machinery such as the back hoe 10.

It should be noted that in the present embodiment, although at least a part of the pump device 30 overlaps with the housing main body 47 in the direction B in which the base 41 extends, it is not limited thereto.

As shown in FIGS. 4 and 5, in the present embodiment, for example, when one looks along the direction B in which the base 41 extends, the cover member 48 and the housing main body 47 have about the same size. For this reason, the cover member 48 and the housing main body 47 almost overlap in the direction B.

However, in cases where one looks at embodiments of the cover member 48 and the housing main body 47 along the direction B and the cover member 48 is larger than the housing main body 47, the cover member 48 does not overlap with the housing main body 47 in the direction B. In cases where the cover member 48 has a portion that protrudes more than the housing main body 47 in a direction intersecting with the direction B (the direction from inside the cover member 48 to the outside thereof) so that the cover member 48 has a portion that does not overlap with the housing main body 47 in the direction B, it is possible to achieve a similar operation and effect as long as at least a portion of the pump device 30 overlaps with the cover member 48 (the above-mentioned portion) in the direction B in which the base 41 extends.

In other words, even in cases where the pump device 30 does not overlap with the housing main body 47 in the direction B in which the base 41 extends, as long as at least a portion of the pump device 30 overlaps with the cover member 48 in the direction B in which the base 41 extends, a similar operation and effect are achieved.

Accordingly, the filter device housing 42 and the pump device 30 are arranged so as to overlap, as long as at least a portion of the pump device 30 overlaps with the filter device housing 42, formed from the housing main body 47 and the cover member 48, in the direction B in which the base 41 extends, thereby making it possible to reduce the installation space of the fuel supply device 20. Consequently, it becomes easy to install the fuel supply device 20 in machinery such as the back hoe 10. This advantageous effect is further enhanced if the entire pump device 30 overlaps in the direction B.

Moreover, it is possible to further reduce the installation space of the fuel supply device 20 by having at least a part of the pump device 30 interposed between the filter device housing 42 and the wall portion 12 so as to overlap with the filter device housing 42 in the direction in which the base 41 extends. Even if the pump device 30 is interposed between the filter device housing 42 and the wall portion 12, the advantageous effect is further enhanced if the entire pump device 30 overlaps with the filter device housing 42 in the direction B.

In the present embodiment, at least a part of the pump device 30 is arranged so as to overlap with the filter device housing 42 in the direction B in which the base 41 extends. However, if, for example, the filter device 40 has a structure provided with components other than the filter device housing 42, then at least a part of the pump device 30 in the direction B in which the base extends may be arranged to overlap with components (the above-mentioned components) other than the filter device housing 42 in the filter device 40.

Accordingly, even if a part of the pump device 30 is arranged to overlap with the filter device 40 (including at least a portion of the components forming the filter device 40, and the filter device housing 42) in the direction B in which the base 41 extends, it is possible to achieve a similar operation and effect. The advantageous effects can be further enhanced if everything overlaps in the direction B.

Moreover, the installation space of the fuel supply device 20 can be reduced even further by interposing at least a part of the pump device 30 between the filter device 40 and the wall portion 12 so as to overlap with the filter device 40 in the direction B in which the base 41 extends. Even if it is interposed between the filter device 40 and the wall portion 12, the advantageous effects can be further enhanced if the entire pump device 30 overlaps with the filter device 40 in the direction B.

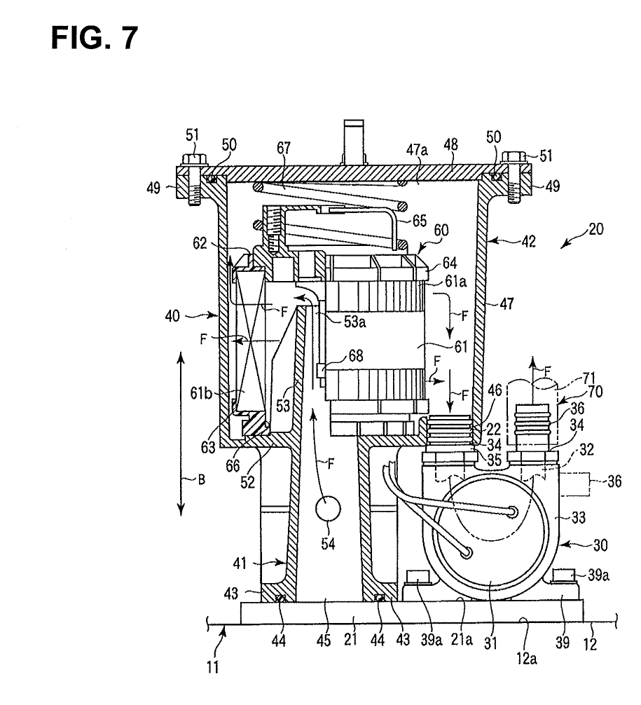

Next, a fuel supply device according to a second embodiment of the present invention is described with reference to FIG. 7. An explanation of reference numerals is omitted for structures having the same function as in the first embodiment. In the present embodiment, the arrangement of the filter device 40 and the pump device 30 differ from the first embodiment. The structure may be identical, except for the items which differ from the above.

The following is a detailed description of the items which differ from the above. FIG. 7 is a sectional diagram illustrating the fuel supply device 20 of the present embodiment, with a portion of the filter device 40 cut-out. In the first preferred embodiment, the pump device 30 is arranged upstream of the filter device 40 in the flow of fuel from the fuel supply source to the fuel tank 13. In the present embodiment, the pump device 30 is arranged downstream of the filter device 40, as shown by the fuel flow arrow in the drawing.

Accordingly, the other end 82 of the second tube member 80 is removably attached to a fuel source such as the fuel reserve tank 18, rather than the fuel tank 13. The other end 72 of the first tube member 70 is coupled to the fuel tank 13. Additionally, the outflow port 46 described in the first embodiment is replaced with the inflow port 54. Furthermore, in the pump device 30, the discharge port 35 described in the first embodiment is replaced with the intake port 34.

In the fuel supply device 20 of the present embodiment, the fuel passes through the filter 61 of the filter device 40 from the inside toward the outside, as shown by the arrow in the drawing. The filtered fuel passes through the pump device housing 33 and enters the fuel tank 13. In other words, the flow is the reverse of the flow in the first embodiment.

In addition to the advantageous effects of the first embodiment, the present embodiment is able to inhibit the effects of debris and other contaminants in the fuel on the pump device 30, since it is able to inhibit debris and other contaminants in the fuel from entering the pump device housing 33.

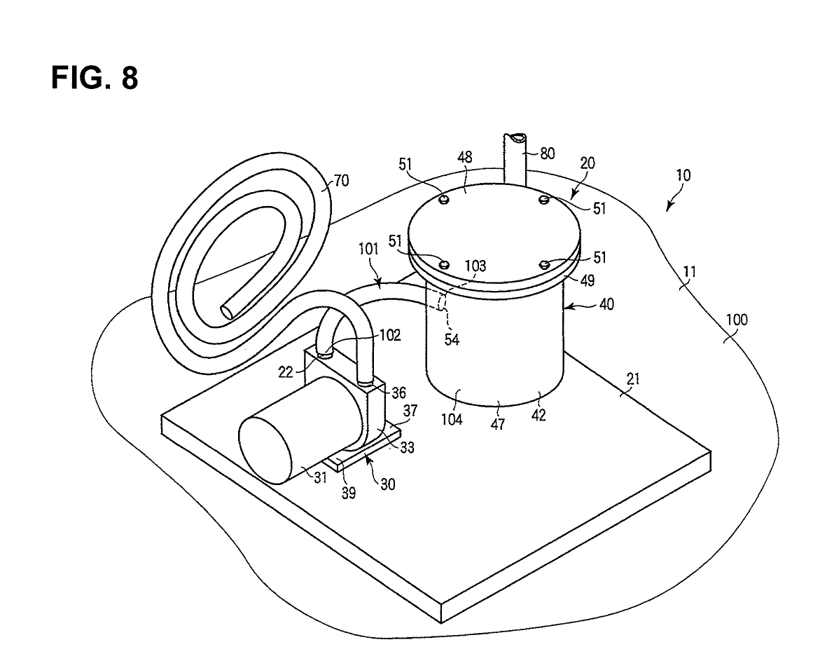

Next, a fuel supply device according to a third embodiment of the present invention is described with reference to FIG. 8. An explanation of reference numerals is omitted for structures having the same function as in the first embodiment. In the present embodiment, the arrangement of the filter device 40 and the pump device 30, as well as the coupling structure for the filter device 40 and the pump device 30 differ from the first embodiment. Other structures may be identical to the first embodiment. The structures differing from the above will be described in detail.

FIG. 8 is a perspective view of the fuel supply device 20 of the present embodiment. As shown in FIG. 8, in the present embodiment, the position in which the fuel supply device 20 is installed differs from the first embodiment. In the present embodiment, the fuel supply device 20 is arranged in another position on the outer wall 11 of the back hoe 10 where the installation space is comparatively wider, thus differing from the first embodiment. In the present embodiment, the position where the fuel supply device 20 is installed is a wall portion 100, which is a position that is different from the wall portion 12 of the outer wall 11 of the first embodiment (the position where the fuel supply device 20 is installed in the first embodiment). The wall portion 100 is in the vicinity of the fuel tank 13.

The filter device 40 of this embodiment does not have a base 41, for example, and thus, the housing main body 47 of the filter device housing 42 is directly affixed to the mounting plate 21. In the present embodiment, as an example, the filter device 40 has the inflow port 54 formed on a side wall 104 of the filter device housing 42. The filter element 60 (which may be cylindrical in shape in one example) is arranged almost concentrically with the filter device housing 42 (cylindrical in shape in one example), and the fuel F is filtered by passing the fuel through the filter element 60 (which is retained within the housing main body 47 and thus not shown) from the outside to the inside.

Within the filter device housing 42 a flow pathway is formed which guides the fuel F to outside of the filter element 60 after the fuel F passes through the filter element 60 but still remains in the filter element 60 after filtration. The fuel F does not flow into the flow pathway prior to being filtered.

In the present embodiment, the outflow port 46 (not pictured) is formed in the side wall 104 of the filter housing device 42, for example. The flow pathway (not pictured) for the fuel F that is filtered as described above is coupled to the outflow port 46 in a fluid-tight manner.

Due to the fact that the filter device 40 has the above-described structure, the fuel F which was filtered by the filter device 40 passes through the second tube member 80 and is supplied to the fuel tank 13.

The pump device 30 is installed at a position that is separated away from the filter device 40, and is affixed to the mounting plate 21. The switches 31a and 31b of the pump device 30 are not illustrated in the present embodiment, but they may be provided to the pump device housing 33 of the pump device 30, for example, rather than to the filter device 40.

The fuel supply device 20 is equipped with a third tube member 101 which couples the pump device 30 and the filter device 40 to each other. One end 102 of the third tube member 101 is affixed and coupled to the coupling member 22 of the pump device housing 33 in a fluid-tight manner. Accordingly, the fuel F (an exemplary embodiment of a fluid referred to in this specification) discharged by the pump device 30 flows into the third tube member 101. The other end 103 of the third tube member 101 is affixed and coupled to the inflow port 54 in a fluid-tight manner. The fuel F passes through the third tube member 101 and flows into the filter device 40. The third tube member 101 is an example of a tube member referred to in this specification.

The following is a description of the operation of the fuel supply device 20 of the present embodiment. By driving the pump device 30, the fuel F is guided into the pump device 30 from the fuel reserve tank 18 through the first tube member 70.

The fuel F is discharged from the pump device 30 into the third tube member 101. The fuel F then flows into the filter device 40 from the third tube member 101 through the inflow port 54. The fuel F filtered by the filter device 40 is discharged into the second tube member 80 through the outflow port 46. The fuel F is then supplied to the fuel tank 13 through the second tube member 80.

Even if the filter device 40 and the pump device 30 have a structure whereby they are coupled to each other and are linked to each other by the third tube member 101, as in the present embodiment, the fuel F is filtered by the filter device 40 before replenishing (before entering) the fuel tank 13. In other words, the fuel supply device 20 is able to filter a fluid such as fuel which it supplies. Accordingly, after filtration, the fuel from which debris and other contaminants have been removed is replenished to the fuel tank 13, thereby making it possible to inhibit debris and other contaminants from remaining in the fuel tank 13.

It should be noted that, although the pump device 30 and the filter device 40 are affixed to the wall portion 100 of the outer wall by the mounting plate 21 in the present embodiment, this affixing structure may be identical to that of the first embodiment. In other words, after the pump device 30 and the filter device 40 are affixed on the mounting plate 21, forming a single unit, the mounting plate 21 is affixed to the wall portion 100, so that it is not limited to being affixed (affixed by the mounting plate 21) to the wall portion 100 (the outer wall 11). The pump device 30 and the filter device 40 may be directly affixed to the wall portion 100.

Moreover, the fuel supply device 20 of the present embodiment may be such that the pump device 30 is disposed downstream from the filter device 40, as described in the second embodiment. In this case, as described in the second embodiment, it is possible to inhibit debris and other contaminants in fuel from entering the pump device housing 33, thereby making it possible to inhibit effects on the pump device 30 caused by debris and other contaminants in the fuel.

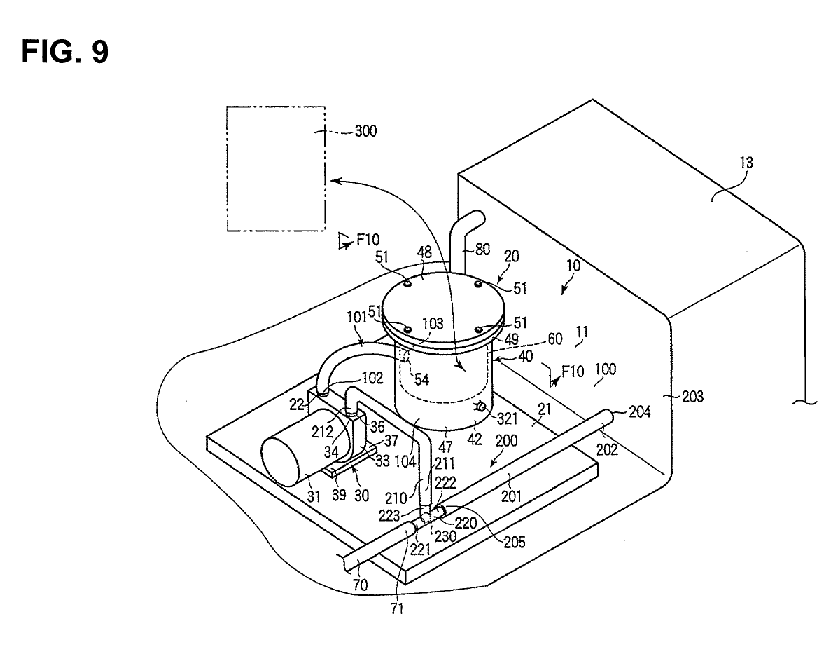

Next, a fuel supply device according to a fourth embodiment of the present invention is described with reference to FIG. 9. An explanation of reference numerals is omitted for structures having the same function as in the first embodiment.

In the present embodiment, moreover, the fuel supply device 20 differs from that of the first embodiment in that it is equipped with a flow pathway which guides the fuel from the fuel tank 13 upstream of the filter device 40 and a switching means. In addition, inclusion of the fuel tank 13 as a structural element of the fuel supply device 20 differs from the third embodiment. Furthermore, the fact that the filter device 40 functions to separate the fuel F from the water W, and has an accompanying peripheral structure, also differs from the third embodiment. Other structures may be identical to the third embodiment. The structures differing from the above will be described in detail.

FIG. 9 is a perspective view illustrating the fuel supply device 20 of the present embodiment. In the present embodiment, the fuel tank 13 is installed adjacent to the fuel supply device 20. The fuel supply device 20 of the present embodiment is equipped with a flow pathway 200. The flow pathway 200 is equipped with a fourth tube member 201, a fifth tube member 210, and a coupling member 220.

One end 202 of the fourth tube member 201 is linked to the fuel tank 13. A linking member 204, with which the end 202 is linked, is formed on a vertical wall 203 of the fuel tank 13. The fourth tube member 201 is linked to the inside of the fuel tank 13.

A coupling member 220, formed in a T-shape, is equipped with three openings 221-223. The openings 221-223 are linked to each other. One end 71 of the first tube member 70 is linked to the opening 221. The first tube member 70 is linked to the coupling member 220 through the opening 221. The other end 205 of the fourth tube member 201 is coupled to the opening 220 of the coupling member 220. The fifth tube member 210 is linked to the coupling member 220 through the opening 222.

One end 211 of the fifth tube member 210 is coupled to the opening 223 of the coupling member 220. The fifth tube member 210 is linked to the coupling member 220 through the opening 223. The other end 212 of the fifth tube member 210 is coupled to the tube member coupling part 36 of the intake port 34 of the pump device 30.

A switching valve 230, which is shown by a dotted line, is provided within the coupling member 220. The switching valve 230 can be operated by an operator from outside of the coupling member 220, for example. The first and second states can be switched by switching the switching valve 230.

The first state is employed when the fuel F within the fuel reserve tank 18 is filtered and then guided into the fuel tank 13. In this first state, the opening 222 is closed such that fuel does not flow through the opening 222 into the fuel tank 13. In other words, a fluid such as fuel cannot flow through the opening 222 in the first state. In the first state, the openings 221 and 223 are linked to each other, and the first tube member 70 and the fifth tube member 210 are linked to each other.

The second state is employed when the fuel F within the fuel tank 13 is filtered using the filter device 40. The second state is a state in which the opening 221 is closed, such that fuel does not flow through the opening 221 into the fuel tank 13. In other words, the second stat is a state in which a fluid such as fuel cannot flow through the opening 221. In the second state, the openings 222 and 223 are linked to each other, and the fourth tube member 210 and the fifth tube member 210 are linked to each other. The switching valve 230 is an exemplary embodiment of the switching means referred to in this specification.

Moreover, the fuel supply device 20 has a separating structure for separating the fuel F and the water W within the fuel tank 13. A filter element for oil-water separation is used when separating the fuel F from the water W. It should be noted that the first to third embodiments utilize the filter element 60, which has a filter 61 for removing debris and other contaminants from the fuel F. In the present embodiment, another filter element 300 is specially provided for oil-water separation, in addition to the filter element 60, which serves as a filter for removing debris and other impurities from the fuel F.

The filter element 300 is equipped with a filter 301 which is capable of the fuel F from the water W, instead of the filter 61. The shape (appearance) of the filter 301 may be identical to that of the filter 61. The other structures may be identical to those of the filter element 60 described in the first embodiment. Accordingly, the size and appearance of the filter element 60 and the filter element 300 may be approximately identical.

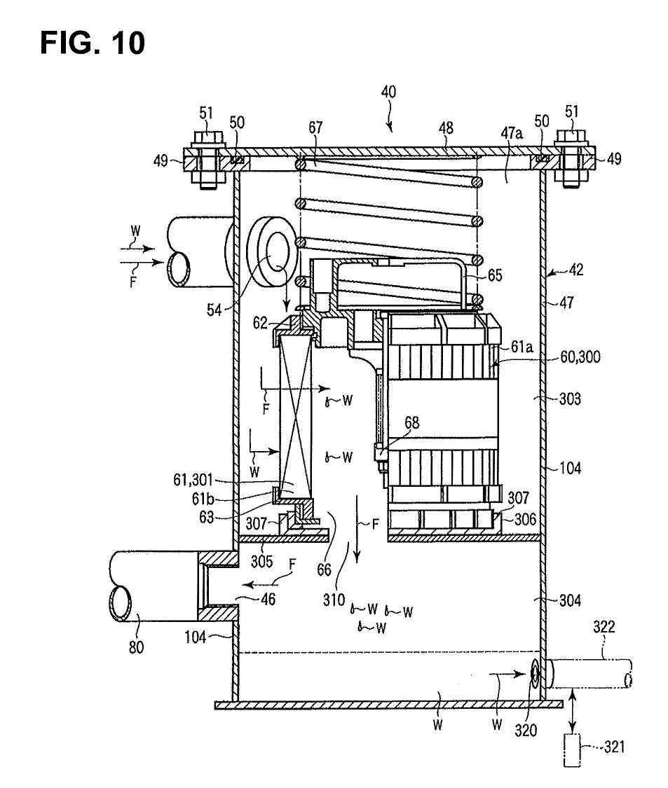

The filter device housing 42 is provided with a structure which separates the fuel F from the water W. FIG. 10 is a sectional view of the filter device 40 along the line F10-F10 in FIG. 9. FIG. 10 shows the inside of the filter device 40. The filter device housing 42 has two chambers 303 and 304 disposed vertically (the direction of gravitational force). The upper chamber 303 and the lower chamber 304 are separated by a separating wall 305. Except for a through-hole 310, discussed below, within the filter device housing 42, the upper chamber 303 and the lower chamber 304 are not linked.

The filter element 60 or the filter element 300 is disposed above the separating wall 305. The separating wall 305 is provided with a positioning plate 306 for positioning the filter elements 60 and 300 (since the filter elements 60 and 300 are approximately identical in appearance).

The positioning plate 306 may be circular, for example, and a rim portion 307 may project around the entire periphery, for example. The shape of the positioning plate 306 is set so that the filter elements 60 and 300 are retained within a specified inside area by the projecting rim portion 307. Accordingly, the position of the filter element 300 within the filter device housing 42 is determined by retaining the filter elements 60 and 300 within the rim portion 307. For example, the filter elements 60 and 300 are disposed in the center of the separating wall 305. The through-hole 310 which is linked to the opening 66 of the second end member 63 of the filter elements 60 and 300 is formed in the center of the separating wall 305 and the positioning plate 306. By closing the cover member 48 the filter elements 60 and 300 are pressed against the positioning plate 306 due to the compressive force of the spring element 67.

The upper chamber 303 is provided with the inflow port 54. The fuel F, filtered by the filter elements 60 and 300 (filters 61, 301), passes through the through-hole 310, and flows into the lower chamber 302. It should be noted that the position which touches the positioning plate 306 in the filter elements 60 and 300 (the lower end of the drawing) is compressed by the spring element 67, thereby making contact with the positioning plate 306 in a fluid-tight manner. Accordingly, the fuel F passing through the filters 61 and 301 does not leak from between the filter element 300 and the positioning plate 306.

The filter 301 functions to separate the fuel F from the water W. In the state prior to passing through the filter 301, the water W present in the fuel F has small particles. The particles of the water W in the fuel F increase in size when they pass through the filter 301. As a result, the water is separated.

The fuel F and the water W which pas through the filter 301 flow through the through-hole 310 into the lower chamber 304. The specific gravity of the fuel F is lower than that of the water W. Thus, since the grains passing through the filter 301 increase in size, the water W separated from the fuel F collects in the lower portion of the lower chamber 304. Accordingly, the outflow port 46 is formed in the upper part of the side wall 104 of the filter device housing 42 in the lower chamber 304. An exhaust port 320 is formed in the bottom part for the water W to escape.

The exhaust port 320 is sealed in a fluid-tight manner by a cover member 321, when the filter element 60 is used to separate debris and other contaminants from the fuel F. The exhaust port 320 allows the separated water W to escape to the outside of the filter device 40 when the fuel F and the water W are separated by the filter element 300, and the cover member 321 is removed so that the exhaust port 320 is linked to an exhaust tube member 322. It should be noted that in FIG. 10, the cover member 321 and the exhaust tube member 322 are shown by double-dashed lines, indicating that they are interchangeable.

The flow rate of fuel guided to the filter device 40 by the pump device 30 is variable. A valve is provided in the vicinity of the pump device 30 in the flow pathway for adjusting the flow rate. Furthermore, the flow rate of the pump device 30 can be adjusted by adjusting the operating capacity of the driving motor of the pump device 30. It should be noted that the structure for varying the flow rate of fuel supplied to the filter device 40 is not limited to the above-described structure. In other words, the flow rate of the fuel delivered to the filter device 40 may be variable.

In cases where the fuel F supplied from the fuel reserve tank 18 is filtered, and in cases where the fuel within the fuel tank 13 is filtered by the filter device 40 (when the filter element 60 is used), the flow rate of fuel supplied to the filter device 40 can, for example, be 50 L/min. When the filter element 300 is used to separate the fuel F and the water W in the fuel tank 13, the flow rate (including fuel and water) supplied to the filter device 40 is set at 2-10 L/min.

As described above, the optimal flow rate (e.g., 50 L/min) for removing debris and other contaminants, and the optimal flow rate (e.g., 2-10 L/min) for removing water, are actually determined in advance.

The following is a description of the fuel supply device 20 of the present embodiment. As described in the first embodiment, when the fuel F in the fuel reserve tank 18, which is filtered by the filter device 40 by passing through the filter device 40, is supplied to the fuel tank 13, the filter element 60 is employed. The switching valve 230 may also be set to the first state by an operator, for example.

Due to the fact that the switching valve 230 is set to the first state, the fuel F within the fuel reserve tank 18 is guided to the filter device 40 through the first tube member 70, the coupling member 220, the fifth tube element 210, the pump device 30, and the third tube member 101. After being filtered by the filter device 40, the fuel F is guided into the fuel tank 13.

At this time, the opening 222 whereby the fourth tube member 201 is coupled within the coupling member 220, and the opening 223 to which the fifth tube member 210 is coupled, are not linked to each other. Accordingly, the fuel F in the fuel tank 13 is not guided again to the filter device 40 through the fourth tube member 201.

The following is a description of the operation of filtering the fuel remaining in the fuel tank 13, by means of the filter device 40. There are cases in which fuel is supplied to the fuel tank 13 without passing through the filter device 40. For example, there are cases in which fuel is directly supplied to the fuel tank 13 from the outside, through a supply port (not pictured) provided to the fuel tank 13.

In this case, the fuel F, which is not filtered by the filter device 40, is guided into the fuel tank 13, so it is conceivable that debris and other contaminants might remain in the unfiltered fuel. Accordingly, when the fuel F is supplied to the fuel tank 13 without passing through the filter device 40, an operation is performed whereby fuel in the fuel tank 13 is filtered using the filter device 40.

Specifically, in addition to using the filter element 60, the switching valve 230 is set to the second state by an operator, for example. When the second state is set by the switching valve 230, the opening 222 whereby the fourth tube member 201 is coupled within the coupling member 220, and the opening 223 to which the fifth tube member 210 is coupled, are linked to each other. Since the opening 221 to which the first tube member 70 is linked is closed, only the fuel F in the fuel tank 13 is guided to the filter device 40 by the pump device 30. After being filtered, the fuel F guided to the filter device 40 is guided again into the fuel tank 13.

The following is a description of the operation of separating the fuel F and the water W in the fuel tank 13. It should be noted that the operation of separating the water W from the fuel F can be carried out. For example, the water W may be separated from the fuel F after filtering the fuel F in the fuel reserve tank 18 with a filter device (the filter element 60) and supplying it to the fuel tank 13 to fill the tank (first state) or after setting the flow pathway 200 to the second state and filtering the fuel F in the fuel tank 13 with a filter device (the filter element 60). However, it should be noted that the operation is not limited thereto.

When separating the water W from the fuel F in the fuel tank 13, the flow pathway 200 is set to the second state. Also, the cover member 48 of the filter device 40 is removed and the filter element 60 is removed. The filter element 300 is then attached (the filter element 60 and the filter element 300 are interchangeable) and the cover member 48 is attached. The flow rate for guiding to the filter device 40 is then set at 1-10 L/min. Next, the cover member 321 is removed, and the exhaust tube member 322 is affixed to the exhaust port 320. Then, the pump device 30 is operated. It should be noted that the sequence of operation up to operation of the pump device 30 is not limited to the above.

Accordingly, the fuel F and the water W in the fuel tank 13 are guided to the filter device 40. As shown in FIG. 10, the particle size of the water W increases due to the fact that the guided fuel F and the water W pass through the filter 301. The fuel F, from which the water W has been separated, flows into the lower chamber 304, after which it passes through the outflow port 46 and is guided to the fuel tank 13. The water W which has passed through the filter 301 to be separated, collects in the lower portion of the lower chamber 304, and is discharged to the outside by the exhaust port 320.

When the pump device 30 has operated for a predetermined time, operation of the pump device 30 ceases. It should be noted that this predetermined time is the time required to separate the fuel F and the water W in the fuel tank 13, and can be computed on the basis of the capacity of the fuel tank 13.

Accordingly, in addition to adjusting the rate of flow to the filter device 40, the function of the filter element 60 is to remove debris and other contaminants and the function of the filter element 300 is to separate the fuel F and the water W are separated from each other, making it possible to switch between the operation of removing debris and other contaminants and the operation of separating the fuel F from the water W.

In addition to the advantageous effects of the third embodiment, the present embodiment makes it possible to remove debris and other contaminants from fuel in the fuel tank 13 in cases where the fuel F is supplied to the fuel tank 13 without passing through the filter device 40. Moreover, the structure can be simplified by using the pump device 30 and the filter device 40 in a structure which filters fuel within the fuel tank 13.

Yet further, the fuel F and the water W in the fuel tank 13 can be separated. Moreover, the structure can be simplified by using the flow pathway 200, the pump device 30, and the filter device 40 in a structure which separates the fuel F and the water W.

It should be noted that in the present embodiment, the structure which incorporates a flow pathway referred to in this embodiment is not limited to the structure of the fuel supply device described in the third embodiment. For example, a fuel supply device 20 described in the first and second embodiments may be provided with a flow pathway, a switching means, and a structure for separating fuel F and water W. In this case, the advantageous effects described in the present embodiment can be achieved, in addition to the advantageous effects of the first and second embodiments.

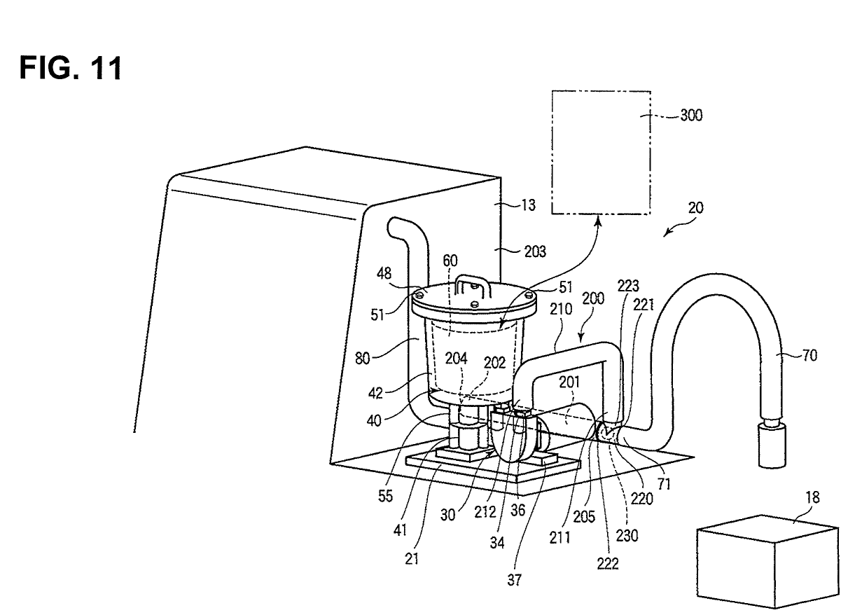

Next, a fuel supply device according to a fifth embodiment of the present invention is described with reference to FIG. 11. In the present embodiment, the fuel supply device 20 described in the first embodiment is further provided with a switching means and a flow pathway for guiding fuel in the fuel tank upstream of the filter device, as described in the fourth embodiment. Additionally, a structure is provided for separating the fuel F and the water W, as described in the fourth embodiment.

Accordingly, the present embodiment differs in that it provides a flow pathway referred to above (e.g., the flow pathway 200) and a switching means (e.g., the switching valve 230) of the first embodiment, and in that it provides a mechanism capable of adjusting the rate of flow to the filter device 40, and a structure equipped with the filter element 300. In the present embodiment, a description of reference numerals for structures having identical functions to those in the first and fourth embodiments is omitted. The items differing from the above will be described in detail.

FIG. 11 shows the fuel supply device 20 of the present embodiment. In the present embodiment, the fuel supply device 20 is equipped with the fuel tank 13, as in the fourth embodiment. As shown in FIG. 11, the fuel tank 13 is arranged in a position adjacent to the fuel supply device 20. The fuel tank 13 is equipped with the flow pathway 200 and the switching valve 230. The filter device 40 is provided with the filter element 300, which is interchangeable with the filter element 60. It should be noted that the filter element 300 is indicated with a double-dashed line in FIG. 2, indicating that it is interchangeable with the filter element 60.

The operation of removing debris and other impurities from the fuel F in the fuel tank 13, and the operation of separating the fuel F and the water W in the fuel tank 13, are identical to those in the fourth embodiment. In the present embodiment, it is possible to achieve the advantageous effects of the first embodiment and the fourth embodiment.

It should be noted that in the fourth and fifth embodiments, the fuel tank 13 is a structural element of the fuel supply device 20, but they are not limited thereto. Likewise, even in the fuel supply device 20 described in the first to the third embodiments, the fuel tank 13 may be a structural element (corresponding to claim 15).

The present invention is not limited to the above embodiments, and the structural elements can be modified and implemented as long as they are within the scope of the invention at the implementation stage. Moreover, a variety of inventions can be embodied by suitably combining the plurality of structural elements disclosed in the above embodiments. For example, a number of structural elements may be eliminated from all of the structural elements described in the above embodiments. Moreover, structural elements which apply to different embodiments may be suitably combined.

What is claimed is:

1. A fluid supply device comprising:
a pump device that moves fluid; and
a filter device that filters fluid which flows due to operation of the pump device.

2. The fluid supply device according to claim 1, wherein the pump device comprises a pump device housing, the pump device housing comprising a first coupling member which enables the fluid to flow therethrough, and wherein the filter device comprises a filter device housing that holds a filter element, the filter device housing having a second coupling member that enables fluid to flow therethrough, wherein the first and second coupling members are coupled to each other.

3. The fluid supply device of claim 3, according to claim 2, wherein the filter device comprises an immobilizing base, and at least a part of the pump device is disposed such that the at least a part of the pump device overlaps with the filter device in a direction in which the base extends.

4. The fluid supply device according to claim 1, wherein the filter device and the pump device are coupled to each other by a tube member that enables the fluid to flow internally between the pump device and the filter device.

5. The fluid supply device according to claim 1, further comprising a pump device tube member coupled to the pump device, and a filter device tube member coupled to the filter device.

6. A fuel supply device, comprising:
a pump device which delivers fuel to the inside of a fuel tank attached to machinery; and
a filter device which filters the fuel before it enters into the fuel tank,
wherein the pump device and the filter device are attached to the machinery.

7. The fuel supply device according to claim 6, wherein the pump device comprises a pump device housing comprising a first coupling member that enables the fuel to flow therethrough, and wherein the filter device comprises a filter device housing which holds a filter element, the filter device housing having a second coupling member that enables fuel to flow therethrough, wherein the first and second coupling members are coupled to each other.

8. The fuel supply device according to claim 7, wherein the filter device and the pump device are affixed to a wall of the device.

9. The fuel supply device according to claim 8, wherein the filter device comprises a base for affixing the filter device to the wall, and at least a part of the pump device is interposed between the filter device and the wall such that the at least a part of the pump device overlaps with the filter device in a direction in which the base extends.

10. The fuel supply device according to claim 6, wherein the filter device and the pump device are coupled by a tube member that enables the fluid to flow internally between the pump device and the filter device.

11. The fuel supply device according to claim 10, wherein the filter device and the pump device are affixed to a wall of the device.

12. The fuel supply device according to claim 11, further comprising a pump device tube member coupled to the pump device, and a filter device tube member coupled to the filter device.

13. The fuel supply device according to claim 6, further comprising a flow pathway which guides the fuel from within the tank to the filter device.

14. The fuel supply device according to claim 13, further comprising a switch that switches between a first condition in which fuel within the tank is not guided to the filter device and a second condition in which the fuel within the tank is guided to the filter device through the flow pathway.

15. The fuel supply device according to claim 6, further comprising a second tank.
